(19) United States
(12) Patent Application Publication
(10) Pub. No.: US 2014/0248519 A1
(43) Pub. Date: Sep. 4, 2014

(54) BATTERY PACK AND ELECTRIC DEVICE

(71) Applicant: HITACHI KOKI CO., LTD., Tokyo (JP)

(72) Inventors: Tomomasa NISHIKAWA, Hitachinaka (JP); Tetsuhiro HARADA, Hitachinaka (JP)

(73) Assignee: HITACHI KOKI CO., LTD., Tokyo (JP)

(21) Appl. No.: 14/174,573

(22) Filed: Feb. 6, 2014

(30) Foreign Application Priority Data
Mar. 1, 2013 (JP) 2013-040678

(51) Int. Cl. H01M 2/10

(52) U.S. Cl. CPC H01M 2/105; H01M 2/1094
USPC 429/99

(57) ABSTRACT

A battery pack that can ensure a sealing property of a housing case and can cool the inside of the housing case is provided. A battery pack has: a housing case that houses a battery cell(s) and can be attached to and detached from a tool main body; an insulating covering material that covers the battery cell in a state in which electrodes of the battery cell are exposed; a holder that retains the battery cell covered with the covering material in the housing case; and an opening portion that is provided in the holder and exposes a part of the battery cell covered with the covering material to a passage of air that flows in the housing case.

### CROSS-REFERENCE TO RELATED APPLICATION

The present application claims priority from Japanese Patent Application No. 2013-040678 filed on Mar. 1, 2013, the content of which is hereby incorporated by reference into this application.

### TECHNICAL FIELD OF THE INVENTION

The present invention relates to a battery pack that can be attached to and detached from an electric device and also to the electric device to which the battery pack is attached.

### BACKGROUND OF THE INVENTION

Conventionally, a battery pack configured to be attachable to and detachable from an electric device has been known, and an example of such a battery pack is described in Japanese Patent Application Laid-Open Publication No. 2008-066141 (Patent Document 1). The battery pack described in Patent Document 1 has a housing case and a holder housed in the housing case. The housing case is provided with an upper case and a lower case. The holder retains a plurality of battery cells, and electrodes of the plurality of battery cells are electrically connected to a board. The board is provided with terminals, and opening portions for exposing the terminals to outside of the housing case are provided on the upper case. An example of a case in which the battery pack described in Patent Document 1 is placed on a main body part of a charger to charge the battery cells of the battery pack is described in Japanese Patent Application Laid-Open Publication No. 2009-289694 (Patent Document 2). The flow of air formed by a cooling fan enters the inside of the housing case through air-intake holes. The air which has entered the housing case absorbs the heat of the battery cells and discharges the heat to outside of the housing case from air-discharge holes.

### SUMMARY OF THE INVENTION

Meanwhile, when charge to the battery cells or discharge with the battery cells is to be carried out, the battery cells may generate heat and increase the temperature in the housing case. However, according to the structure described in Patent Document 2, although the inside of the housing case can be cooled by a cooling fluid, waterproof of a case in which rainwater, etc. enter the inside of the housing case from the air-intake holes is not taken into consideration.

It is an object of the present invention to provide a battery pack and an electric device that can ensure sealing properties of battery cells and can cool the battery cells.

A battery pack including: a housing case that houses a battery cell and can be attached to and detached from an electric-device main body; an insulating covering material that covers the battery cell in a state in which electrodes of the battery cell are exposed; a holder that retains the battery cell covered with the covering material in the housing case; and an opening portion that is provided on the holder and exposes a part of the battery cell covered with the covering material to a passage of air that flows in the housing case.

An electric device including: a battery pack that houses a battery cell; and an electric-device main body to and from which the battery pack can be attached and detached, the battery pack including a housing case that houses the battery cell and can be attached to and detached from the electric-device main body, an insulating covering material that covers the battery cell in a state in which electrodes of the battery cell are exposed, a holder that retains the battery cell covered with the covering material in the housing case, and an opening portion that is provided in the holder and exposes a part of the battery cell covered with the covering material to a passage of air that flows in the housing case.

According to the battery pack of the present invention, the sealing properties of the battery cells can be ensured, and the battery cells can be cooled.

### BRIEF DESCRIPTIONS OF THE DRAWINGS

FIG. 1 is a perspective view showing an electric power tool, which is an example of an electric device of the present invention;

FIG. 2 is a perspective view showing an example of a battery pack of the present invention;

FIG. 3 is a perspective view of the battery pack shown in FIG. 2;

FIG. 4 is an exploded perspective view of the battery pack shown in FIG. 2;

FIG. 5 is a bottom view of a holder housed in the battery pack shown in FIG. 4;

FIG. 6 is a conceptual diagram of a state in which the battery pack of the present invention is placed on a charger;

FIG. 7 is a cross-sectional view of a battery cell housed in the battery pack of the present invention; and

FIG. 8 is an exploded perspective view showing an air route of the battery pack of the present invention.

### DESCRIPTIONS OF THE PREFERRED EMBODIMENT

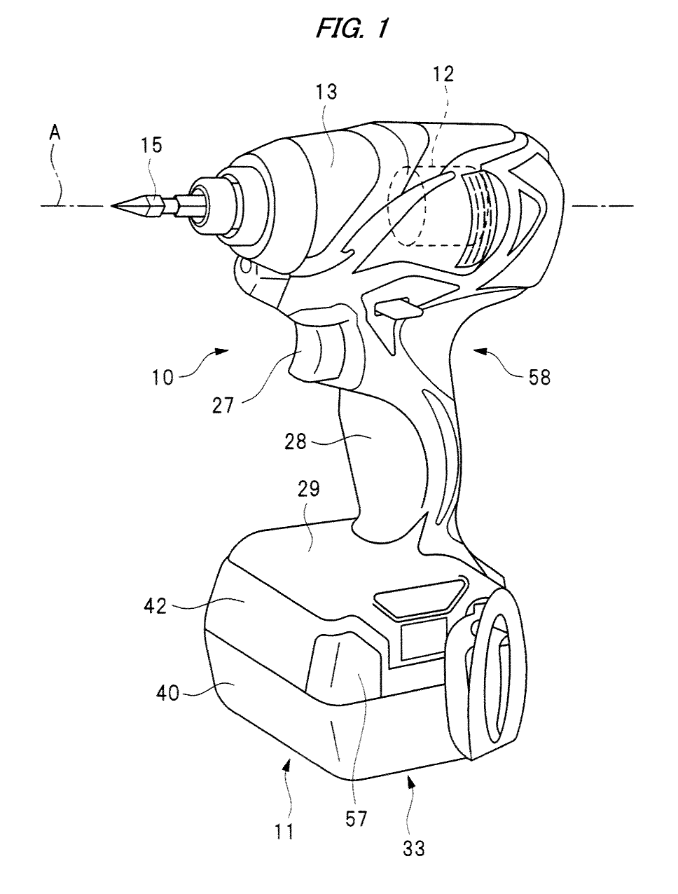

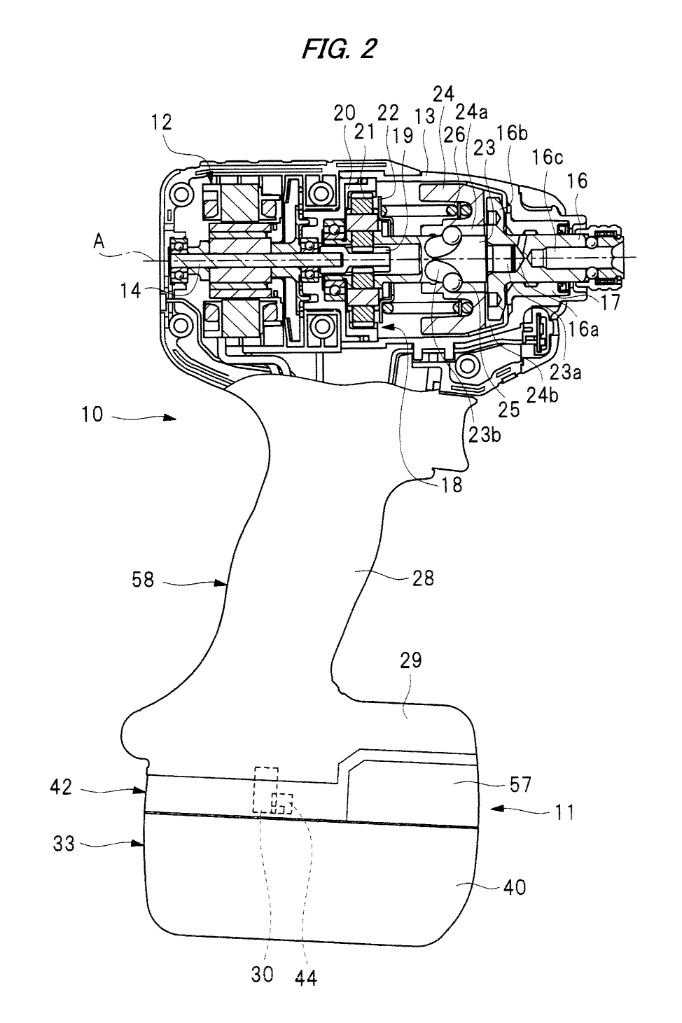

An embodiment of an electric device and a battery pack of the present invention will be explained in detail by using drawings. FIG. 1 and FIG. 2 show an electric power tool 10, which is an example of the electric device. The electric power tool 10 shown in FIG. 1 and FIG. 2 is an impact driver. The electric power tool 10 has a tool main body 58 and a battery pack 11. The tool main body 58 corresponds to a main body of the electric device (hereinafter, called electric-device main body) of the present invention. The tool main body 58 has a casing 13, a grip 28, and an attachment part 29. An electric motor 12 is provided in the casing 13. The electric motor 12 has a rotating shaft 14, and the rotating shaft 14 rotates about an axis line A. The electric motor 12 is a brushless motor, and a stator of the electric motor 12 has a coil corresponding to three phases, i.e., a U-phase, a V-phase, and a W-phase. The electric power tool 10 has an anvil 16 to/from which a tip tool 15 is attached/detached, and the anvil 16 is rotatably supported by a sleeve 17 attached to the casing 13. The anvil 16 can be rotated about the axis line A.

On the other hand, a speed reducer 18 is provided in the casing 13. In the direction along the axis line A, the speed reducer 18 is disposed between the electric motor 12 and the anvil 16. The speed reducer 18 is a motive-power transmitting device which transmits the torque of the electric motor 12 to the anvil 16, and the speed reducer 18 is comprised of a planetary gear mechanism of a single-pinion type. The speed reducer 18 has a sun gear 19 disposed on the same axis with that of the rotating shaft 14, a ring gear 20 provided so as to surround the outer peripheral side of the sun gear 19, and a carrier 22 supporting a plurality of pinion gears 21 meshed with the sun gear 19 and the ring gear 20 so that the pinion gears can be subjected to rotation and revolution. The ring gear 20 is fixed to the casing 13 and cannot be rotated. A spindle 23 which is integrally rotated about the axis line A together with the carrier 22 is provided. The spindle 23 is disposed between the anvil 16 and the speed reducer 18 in the direction along the axis line A, and a shaft part 23a projecting in the direction along the axis line A is formed at an end of the spindle 23 in the anvil 16 side.

On the outer peripheral surface of the spindle 23, substantially V-shaped cam grooves 23b are provided. On the other hand, a retention hole 16a which is coaxial with the axis line A is provided at an end of the anvil 16 in the spindle 23 side, and the shaft part 23a is rotatably inserted in the retention hole 16a. More specifically, the anvil 16 and the spindle 23 can be relatively rotated about the axis line A. Furthermore, the anvil 16 is provided with an attachment hole 16c coaxial with the axis line A. The attachment hole 16c is formed at a part of the anvil 16 exposed to outside of the casing 13, and the attachment hole 16c is provided for attaching/detaching the tip tool 15.

On the outer periphery of the spindle 23, an annular hammer 24 is attached. The hammer 24 is disposed between the speed reducer 18 and the anvil 16 in the direction along the axis line A. The hammer 24 can be relatively rotated with the spindle 23 and can be relatively moved with the spindle 23 in the direction along the axis line A. On the inner peripheral surface of the hammer 24, cam grooves 24a extending in the direction along the axis line A are formed. Steel balls 25 are retained by the cam grooves 23b and the cam grooves 24a. Therefore, the hammer 24 can be moved in the direction along the axis line A within a range in which the steel balls 25 can be rolled with respect to the spindle 23. Moreover, the hammer 24 can be moved in the rotating direction about the axis line A within a range in which the steel balls 25 can be rolled with respect to the spindle 23.

Furthermore, a compressed spring 26 is provided between the hammer 24 and the carrier 22 in the direction along the axis line A, and the pressing force of the compressed spring 26 is applied to the hammer 24. The hammer 24 is pushed toward the anvil 16 in the direction along the axis line A by the pressing force of the compressed spring 26.

At ends of the anvil 16 in the hammer 24 side, projecting parts 16b projecting in the radial direction thereof are provided. The two projecting parts 16b are provided at an interval of 180 degrees in the circumferential direction of the anvil 16. On the other hand, at ends of the hammer 24 in the anvil 16 side, projecting parts 24b projecting in the direction along the axis line A are provided. The two projecting parts 24b are provided at an interval of 180 degrees in the circumferential direction of the hammer 24. The projecting parts 16b and the projecting parts 24b are disposed on the same circumference about the axis line A, and the projecting parts 16b and the projecting parts 24b can be engaged with and released from each other.

The casing 13 is provided with a trigger switch 27, and the trigger switch 27 is operated by an operator. In the casing 13, a motor driving device to which an operation signal of the trigger switch 27 is input is provided. The motor driving device is provided with an inverter circuit provided with a bridge circuit and a control circuit that controls the inverter circuit. The motor driving device controls the drive currents supplied from the battery pack 11 to the stator.

Next, working of the electric power tool 10 will be explained. When the electric motor 12 is stopped, the hammer 24 pressed by the compressed spring 26 is stopped at a position that is the closest to the anvil 16 in the direction along the axis line A. Therefore, the projecting parts 24b of the hammer 24 and the projecting parts 16b of the anvil are at the same positions in the direction along the axis line A. Then, when electric power is supplied to the electric motor 12 to rotate the rotating shaft 14, the torque of the rotating shaft 14 is transmitted to the sun gear 19 of the speed reducer 18. When the torque is transmitted to the sun gear 19, the ring gear 20 serves as a reaction force element, and the carrier 22 serves as an output element. More specifically, when the torque of the sun gear 19 is transmitted to the carrier 22, the rotating speed of the carrier 22 is reduced with respect to the rotating speed of the sun gear 19, thereby amplifying output torque. When the torque is transmitted to the carrier 22, the spindle 23 is integrally rotated with the carrier 22. The torque of the spindle 23 is transmitted to the hammer 24 via the steel balls 25. The torque of the hammer 24 is transmitted to the anvil 16 by the engagement force of the projecting parts 24b and the projecting parts 16b, and the anvil 16 is rotated. When the anvil 16 is rotated, a bolt retained at the tip tool 15 is rotated, and the bolt is screwed into an object such as a timber.

Then, the bolt is screwed into the object, the friction resistance of the contact parts of the object and the bolt is increased, and the torque required for rotating the tip tool 15 is increased; as a result, the rotation number of the anvil 16 is reduced. Also, the engagement reaction force at the contact parts between the projecting parts 16b and 24b is increased, and the steel balls 25 are rolled along the cam grooves 23b; as a result, the spindle 23 and the hammer 24 are relatively rotated, and the force that moves the hammer 24 toward the speed reducer 18 along the axis line A is generated. Therefore, the hammer 24 is moved in the direction toward the speed reducer 18 against the pressing force of the compressed spring 26, the projecting parts 16b and the projecting parts 24b are released, and the torque of the hammer 24 is not transmitted to the anvil 16. Thus, the anvil 16 is stopped.

On the other hand, the hammer 24 continues rotating, and the projecting pars 24b are moved over the projecting parts 16b in the circumferential direction about the axis line A. Then, when the steel balls 25 are moved by a predetermined distance along the cam grooves 23b, the pressing force applied from the compressed spring 26 to the hammer 24 becomes larger than the force in the direction that moves the hammer 24 toward the speed reducer 18, and the steel balls 25 are rolled along the cam grooves 23b; as a result, while the hammer 24 and the spindle 23 are relatively rotated, the hammer 24 is moved in the direction along the axis line A, and the projecting parts 24b of the hammer 24 and the projecting parts 16b of the anvil 16 are engaged with each other again. As a result, the torque of the hammer 24 is rapidly transmitted to the anvil 16. More specifically, striking torque in the rotating direction is applied to the anvil 16. Thereafter, engagement and release of the projecting parts 24b of the hammer 24 and the projecting parts 16b of the anvil 16 are repeated, and intermittent striking torque can be transmitted to the bolt via the tip tool 15.

The grip 28 continued to the casing 13 is provided, and the attachment part 29 is provided at an end of the grip 28. The attachment part 29 is provided with a tool-side terminal 30. The tool-side terminal 30 is electrically connected to the control circuit. The battery pack 11 is attachable to and detachable from the attachment part 29.

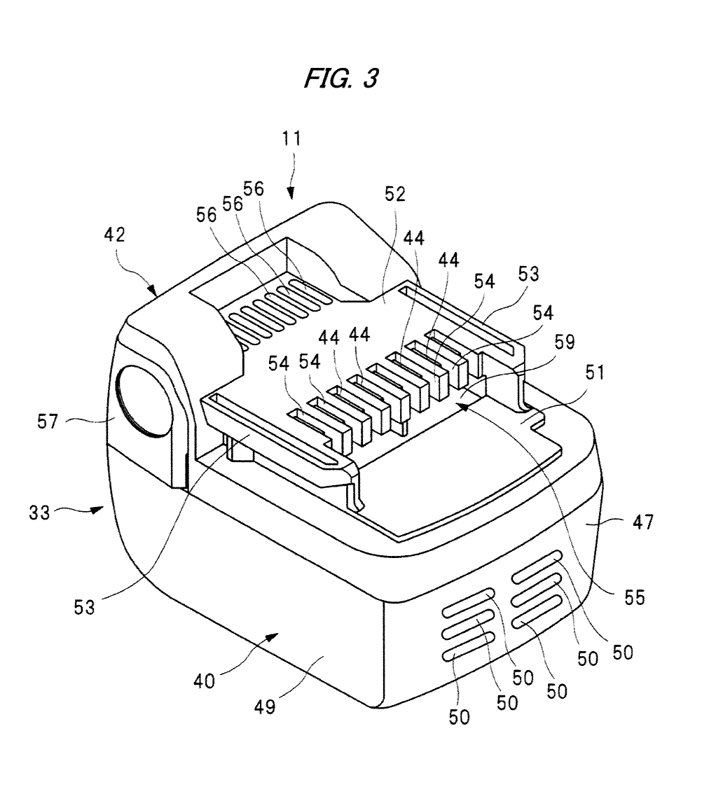

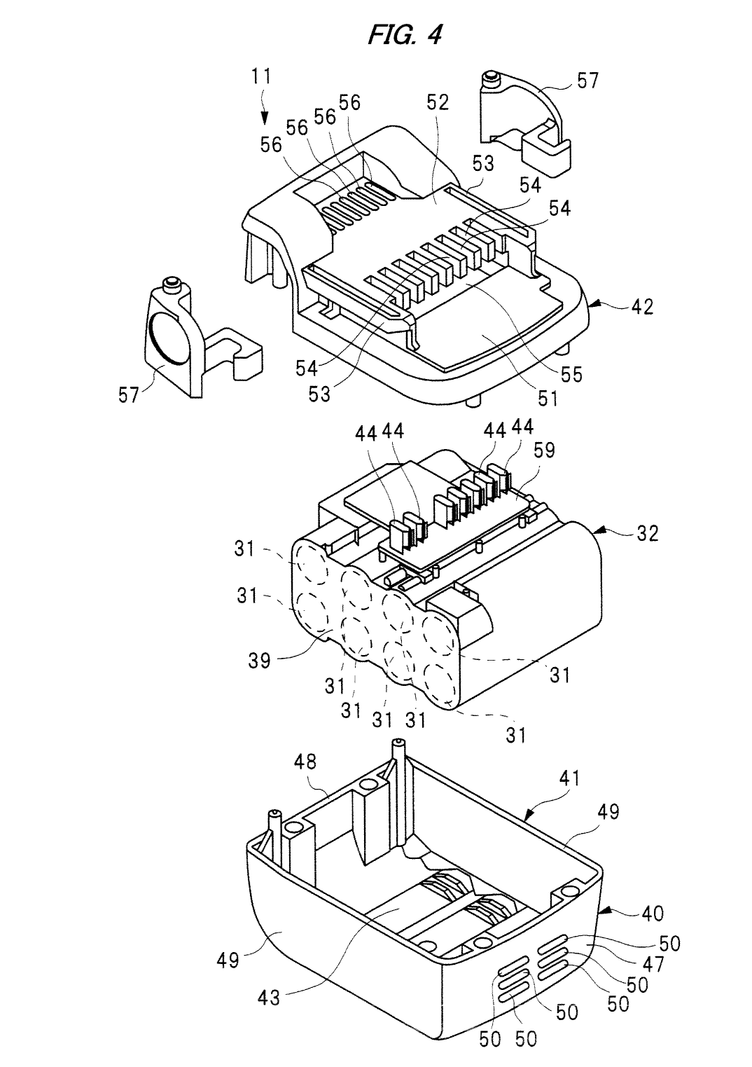

The configuration of the battery pack 11 will be explained based on FIG. 3 to FIG. 6. The battery pack 11 has a plurality of battery cells 31, a holder 32 which holds the plurality of battery cells 31 in a mutually parallel state, and a housing case 33 which houses the holder 32 retaining the battery cells 31. The holder 32 is also referred to as a separator and is fixed so that the plurality of battery cells 31 are not moved in the housing case 33. The housing case 33 has a case main body 40 and a cover 42 covering an opening portion 41 of the case main body 40. The battery cells 31 are secondary batteries which can be repeatedly charged and discharged. Examples of the battery cells 31 include lithium-ion battery cells, nickel-hydrogen battery cells, lithium-ion polymer battery cells, and nickel-cadmium battery cells.

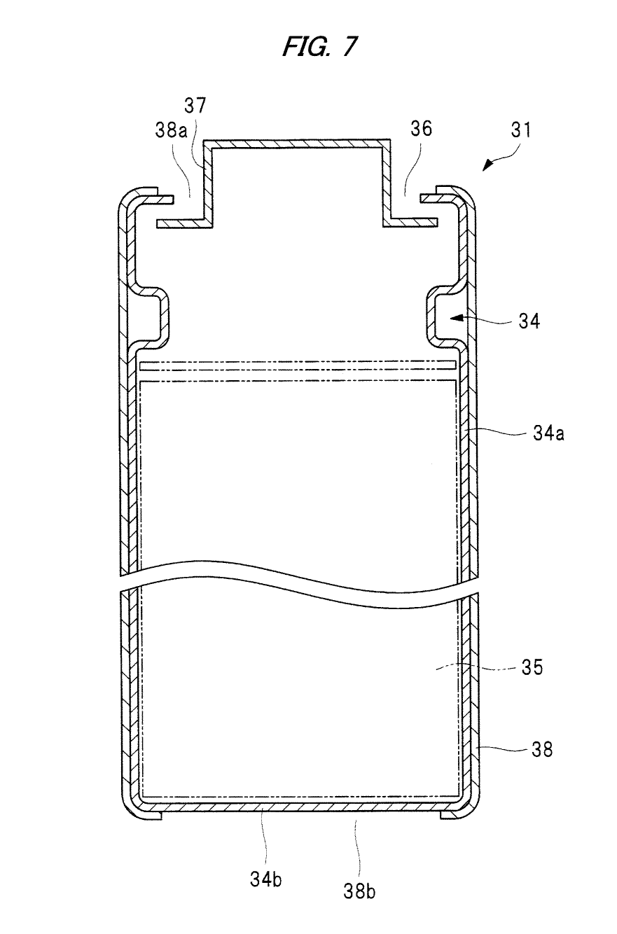

FIG. 7 shows a structure example of the battery cell 31. The battery cell 31 as a whole is cylindrical, and the battery cell 31 has a battery can 34. The battery can 34 has been formed into a bottomed cylindrical shape by press forming of a metal material such as a steel plate or stainless steel having a nickel-plated surface. The battery can 34 forms an electrode, specifically, a negative electrode of the battery cell 31, and the battery can 34 has a body part 34a and a bottom part 34b. In the battery can 34, an electrode body 35 and a non-aqueous electrolyte solution are housed. A cap 37 is provided at the opening portion 36 of the battery can 34. The cap 37 is an element that functions as an electrode, specifically, a positive electrode of the battery cell 31. Thus, the battery cell 31 has the battery can 34 and the cap 37 as two electrodes having different polarities. The cap 37 and the battery can 34 are electrically conductive metal materials such as press-formed aluminum.

Furthermore, the outer peripheral surface of the battery can 34 is covered with a cylindrical tube 38. The tube 38 corresponds to a covering material of the present invention, and the tube 38 has an electrically insulating property and thermal conductivity. As the tube 38, for example, a thermal shrinking tube integrally formed by combining a polyester resin and a thermally-conductive filler can be used. The tube 38 is cylindrical, and the tube 38 has opening portions 38a and 38b at both ends. The cap 37 is exposed to atmospheric air from the opening portion 38a, and the bottom part 34b is exposed to atmospheric air from the opening portion 38b.

The holder 32 retains the plurality of battery cells 31 so that they are mutually parallel, and the holder 32 has a role as an insulator that covers the plurality of battery cells 31. In the present specification, the plurality of battery cells 31 are sometimes described as a group of battery cells 31. The holder 32 has a tubular shape, and the group of the battery cells 31 is housed therein. The holder 32 has a tubular structure having opening portions at both ends.

In the above-described holder 32, the four battery cells 31 are aligned in parallel to form one row, and the eight battery cells 31 in two rows are housed therein. The four battery cells 31 form one set, and each of two sets of the battery cells 31 is individually serially connected. In the one set of the serially connected four battery cells 31, a first connecting member is connected to a positive electrode of the battery cell 31 positioned at a first end. On the other hand, in the one set of the four serially connected battery cells 31, a second connecting member is connected to a negative electrode of the battery cell 31 positioned at a second end.

In the present embodiment, the first connecting member and the second connecting member electrically connecting the electrodes are formed of a metal material having electrical conductivity. Examples of the metal material include, in addition to copper, aluminum, etc., a material which is a rolled steel plate having a nickel-plated surface. The surfaces in the opposite side of the parts of the first connecting member and the second connecting member which are in contact with the electrodes are covered with an insulating member 39. Examples of the material used as the insulating member 39 include an insulating tape or an insulating sheet using a resin film as a base material, a rubber-like elastic body, and a metal plate having a surface on which an insulating layer formed of a resin material is formed. The opening portions of the holder 32 and the gaps between the insulating member 39 and opening edges of the holder 32 can be covered with a sheet member, silicon, clay, etc. having a water-proof property.

In a state in which the holder 32 is housed in the housing case 33, a control board 59 is attached to the cover 42 side of the holder 32. The control board 59 is an electrically non-conductive resin material formed into a flat plate shape. A plurality of battery-side terminals 44 are attached to the control board 59. The plurality of battery-side terminals 44 are formed of an electrically-conductive metal material. The above-described first connecting member and the second connecting member are connected to the battery-side terminals 44 via electric wires.

Furthermore, in the holder 32, at the parts of the case main body 40 in the side of a bottom part 43, four opening portions 45 are provided. The four opening portions 45 are provided to correspond to the four battery cells 31. The planar shape of each of the opening portions 45 is rectangular, and ribs 45b are provided between mutually adjacent opening portions 45. The opening portions 45 are set to a size with which the battery cells 31 are not removed therefrom. The four opening portions 45 communicate the outside and inside of the holder 32 to each other. The part of each of the battery cells 31 covered with the tube 38 is exposed to the opening portion 45. Seal materials 46 are respectively provided along edges 45a of the holder 32 forming the opening portions 45. The seal materials 46 are formed of, for example, rubber-like elastic bodies, silicone, etc.

The seal material 46 may have any of: a structure that is fixed to the edge 45a and in contact with the surface of the battery cell 31, a structure that is fixed to both of the edge 45a and the surface of the battery cell 31, and a structure that is coated on both of the edge 45a and the surface of the battery cell 31. In this manner, the boundary between the surface of the tube 38 of the battery cell 31 and the edge 45a of the holder 32 is sealed by the seal material 46. Also in a case in which the opening portion 45 is not provided at each of the battery cells 31 but is continuously formed across the plurality of battery cells, similarly, the seal material 46 can be provided at the edges 45a of the opening portions 45.

The housing case 33 is an element which houses the holder 32 retaining the plurality of battery cells 31. Both of the case main body 40 and the cover 42 are mutually separately formed of electrically non-conductive materials. Examples of the electrically non-conductive materials include resin materials. The above-described case main body 40 has the bottom part 43, a front wall 47 formed to be continued to outer peripheral edges of the bottom part 43, a rear wall 48, and two lateral walls 49. When the case main body 40 is viewed in a plan view, the bottom part 43 is substantially rectangular. In a state in which the holder 32 retaining the battery cells 31 are housed in the housing case 33, a passage 66 is formed between the bottom part 43 and the four battery cells 31 exposed from the opening portions 45. The passage 66 is a passage through which air, which has entered the inside of the housing case 33, passes.

Furthermore, on the front wall 47, a plurality of vent holes 50, which communicate the inside and outside of the housing case 33 to each other, are provided. In other words, the plurality of vent holes 50 are provided to penetrate through the front wall 47 in the thickness direction thereof. The plurality of vent holes 50 are disposed along the height direction of the battery pack 11. Herein, the height direction refers to the top-bottom direction of the housing case 33 in a state in which the axis line A is substantially horizontal and the battery pack 11 is attached to the attachment part 29. The plurality of vent holes 50 are passages through which the air in the housing case 33 is discharged to outside. When the front wall 47 is viewed from the front, the vent holes 50 may have any shapes such as rectangular shapes, elliptical shapes, circular shapes, etc.

On the other hand, the cover 42 is provided with a plate part 51 and a mount part 52. In both sides of the mount part 52, guide rails 53, which are used for attaching the battery pack 11 to the attachment part 29, are provided, respectively. Between the two guide rails 53 of the mount part 52, a plurality of terminal insertion holes 54 are provided. The plurality of terminal insertion holes 54 penetrate through the housing case 33 from the inside to outside thereof like slits.

The plurality of terminal insertion holes 54 are disposed to be parallel to the guide rails 53. When the battery pack 11 is viewed in a plan view, the plurality of terminal insertion holes 54 are disposed immediately above the plurality of battery-side terminals 44. A window 55 is provided at a boundary part of the mount part 52 and the plate part 51. The window 55 is connected to the plurality of terminal insertion holes 54. In a state in which the cover 42 is attached to the case main body 40, the plurality of battery-side terminals 44 are inserted in the plurality of terminal insertion holes 54. Furthermore, the cover 42 is provided with a plurality of vent holes 56, which communicate the inside and outside of the housing case 33. Furthermore, operation buttons 57 are attached to the cover 42.

Next, an operation of attaching the battery pack 11 to the tool main body 58 will be explained. The battery pack 11 and the tool main body 58 are moved to be close to each other, and the battery pack 11 is moved along the guide rails 53, thereby attaching the battery pack 11 to the attachment part 29 of the tool main body 58. During the process of attaching the battery pack 11 to the attachment part 29, tool-side terminals 30 enter the terminal insertion holes 54, and the tool-side terminals 30 and the battery-side terminals 44 are connected to each other. When the trigger switch 27 is operated, the electric power of the battery cells 31 housed in the battery pack 11 is supplied to the electric motor 12, and the rotating shaft 14 of the electric motor 12 is rotated.

Part of motive power of the electric motor 12 is transmitted to a fan attached to the rotating shaft of the electric motor 12 in the casing 13, and the fan is rotated to form flows of air that cools the electric motor 12. The air outside of the casing 13 is taken into the casing 13 and cools the electric motor 12, the inverter circuit, etc. Particularly, the inverter circuit is provided with a switching element (for example, FET) serving as a control element which controls the motor; therefore, the switching element can be efficiently cooled. The air that has cooled the electric motor 12, etc. is discharged to outside of the casing 13 from air-discharging opening portions formed on the casing 13.

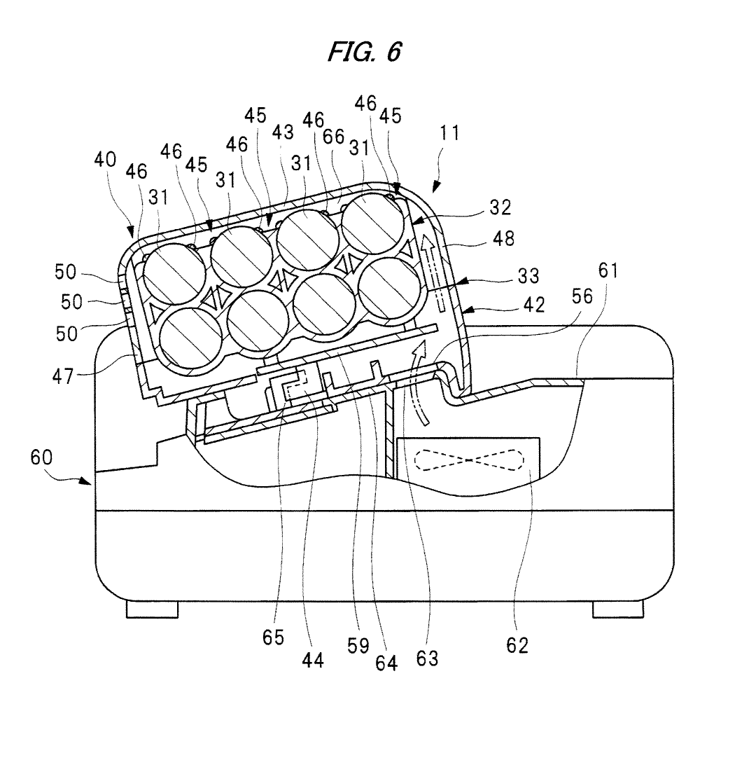

A schematic configuration of a charger, which charges the battery pack 11, will be explained based on FIG. 6. The charger 60 corresponding to the electric-device main body of the present invention has a main body part 61, and a cooling fan 62 is provided in the main body part 61. The main body part 61 is provided with vent holes 63 through which the winds created by the cooling fan 62 pass. Furthermore, the main body part 61 is provided with a mount 64, which supports the battery pack 11, and the mount 64 is provided to be inclined with respect to the horizontal line. The mount 64 is provided with terminals 65. When the battery pack 11 detached from the tool main body 58 is placed on the mount of the charger 60 as shown in FIG. 6, the terminals 65 of the charger 60 are connected to the battery-side terminals 44. Therefore, the battery cells 31 can be charged.

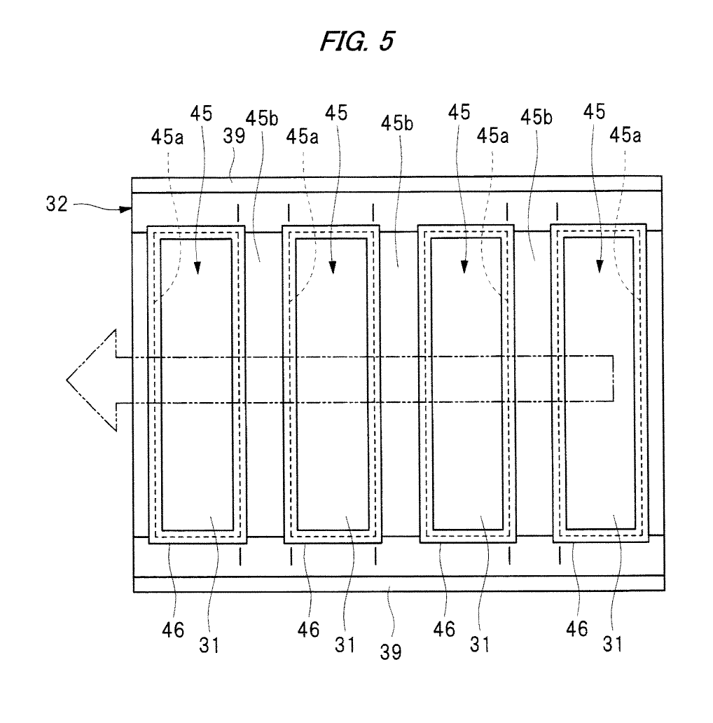

On the other hand, when the battery pack 11 is placed on the mount 64, the vent holes 56 of the housing case 33 are positioned at the positions opposed to the vent holes 63. When the cooling fan 62 is rotated, the winds created by the cooling fan 62 enter the inside of the housing case 33 thorough the vent holes 63 and 56. The air which has entered the inside of the housing case 33 passes through the passage 66 through the part between the holder 32 and the rear wall 48 and is discharged from the plurality of vent holes 50 to outside of the housing case 33. In FIG. 5, the flowing direction of the air which passes through the lower side of the holder 32 is shown by an arrow of a two-dot chain line.

Thus, the air which has entered the inside of the housing case 33 flows in a trajectory of an L-shape when viewed from the lateral side of the battery pack 11. When the air in the housing case 33 flows to the vicinity of the front wall 47, the air passes through the vent holes 50 and is discharged to outside of the housing case 33. The flowing direction of the air in the housing case 33 is the direction that intersects with the center line of the battery cells 31 as shown in FIG. 5. In FIG. 5, the center line of the battery cells 31 is omitted. Therefore, the flow of air in the housing case 33 is not disturbed. In other words, the air can be prevented from remaining in the housing case 33, and cooling performance of the battery cells 31 can be prevented from being reduced.

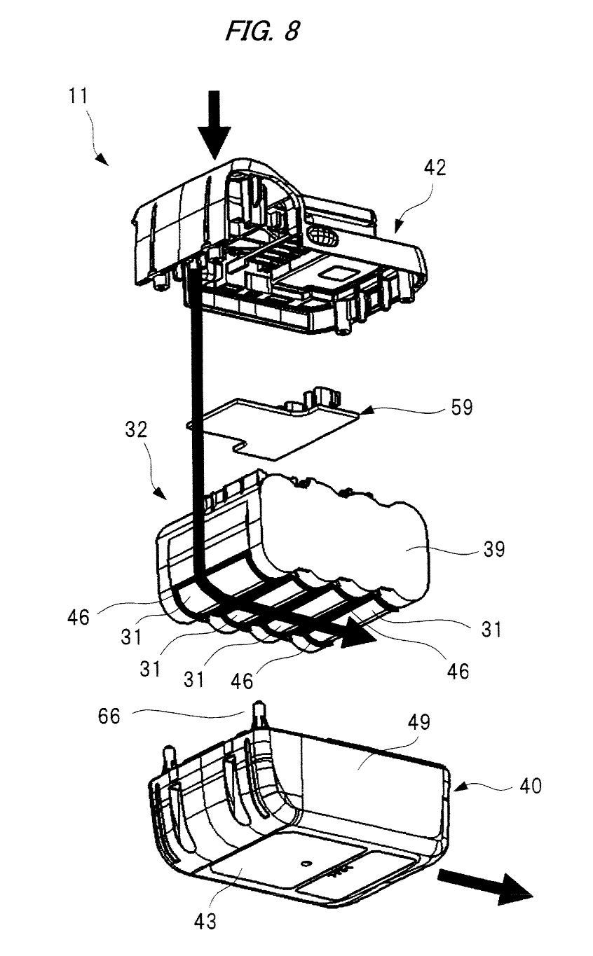

Furthermore, the seal materials 46 are provided at the boundaries (gaps) between the battery cells 31 and the edges 45a of the holder 32. Therefore, foreign matters which have entered the housing case 33 together with the air can be prevented from entering the holder 32. As shown in FIG. 8, the passage 66 is formed between the inner surface of the bottom part 43 of the case main body 40 and the battery cells 31 disposed to be opposed to the bottom part 43. Thus, the passage is not formed between the cover 42 and the battery cells 31 opposed to the cover 42. A reason therefor is that the battery pack 11 is increased in size if the passage of air is formed after providing water-proof coating on the control board 59, etc. although cooling the battery cells 31 is the most effective.

Therefore, in order to carry out cooling while suppressing the increase in size of the battery pack 11, when one of the rows of the battery cells 31 aligned in the upper and lower sides is cooled, the heat of the battery pack 11 of the other row can be cooled by thermal transmission. If the size increase of the battery pack 11 is not taken into consideration, a passage(s) with which all the battery cells 31 can be cooled may be formed, or a passage may be formed between the cover 42 and the battery cells 31 opposed to the cover 42.

The parts of the battery cells 31 covered with the tubes 38 are exposed from the opening portions 45 and disposed in the passage 66. Therefore, the air which passes through the passage 66 is brought into contact with the tubes 38 covering the battery cans 34, and the heat of the battery cans 34 is transmitted to the air via the tubes 38. In this manner, heat exchange is carried out between the battery cells 31 and the air, and the battery cells 31 are cooled.

Next, another structure example of the tool main body 58 will be explained. The tool main body 58 may have a structure in which, in a state in which the battery pack 11 is attached to the attachment part 29, part of the air which cools the electric motor 12 is sent to the inside of the grip 28, the inside of the attachment part 29, and the inside of the housing case 33 through the vent holes 56. Thus, the vent holes 56 function as inflow openings of air. The air sent to the inside of the housing case 33 passes through the passage 66 through the part between the holder 32 and the rear wall 48 and is discharged to outside of the housing case 33 from the plurality of vent holes 50.

Particularly, in the case of the electric power tool 10, it is conceivable that a large current such as 20 A flows to the battery cells 31 depending on load, wherein the temperatures of the battery cells 31 are increased. Therefore, when the battery cells 31 are cooled upon usage of the electric power tool 10, the temperature increase of the battery cells 31 can be suppressed, and deterioration of the battery cells 31 can be suppressed.

As described above, while the air passes through the inside of the housing case 33, heat exchange is carried out between the air and the battery cells 31. Therefore, the battery cells 31 can be cooled in the state in which the battery pack 11 is attached to the tool main body 58. Particularly, when the battery cells 31 are charged with a large current such as 10 A, charging time can be shortened; however, the temperatures of the battery cells 31 are increased. Therefore, when the battery cells 31 are brought into contact with the air, the temperature increase of the battery cells 31 can be suppressed, and rapid charge can be carried out. When the operation buttons 57 are pushed in the state in which the battery pack 11 is attached to the tool main body 58 and the battery pack 11 and the tool main body 58 are relatively moved in the opposite direction of the above-described one, the battery pack 11 can be detached from the tool main body 58.

Meanwhile, in any of: a state in which the battery pack 11 is attached to the tool main body 58, a state in which the battery pack 11 is detached from the tool main body 58, or a state in which the battery pack 11 is attached to the charger 60, foreign matters of outside of the housing case 33 may enter the inside of the housing case 33 from at least one part of the gap between the case main body 40 and the cover 42, the vent holes 50 and 56, the gaps between the operation buttons 57 and the cover 42, and the terminal insertion holes 54. Examples of the foreign matters include water, dust, mud, etc. Since the electric power tool 10 is a cordless type, the electric power tool 10 can be used at any location. More specifically, the electric power tool 10 is often used in a bad environment such as building dismantling working sites, environments full of dust, cases of rain, etc.

Against this circumstance, the seal materials 46 are provided along the edges 45a of the holder 32. More specifically, the seal materials 46 cover and seal the parts between the surfaces of the tubes 38 covering the battery cells 31 and the edges 45a forming the opening portions 45. Therefore, the foreign matters which have entered the inside of the housing case 33 can be prevented from entering the inside of the holder 32 through the opening portions 45. Therefore, the electrodes of the battery cells 31 can be prevented from being short-circuited with each other and from being corroded. Furthermore, dust and water droplets can be prevented from being attached to all of the parts where electric charge is generated at the battery cells 31. Thus, reduction in the life of the battery cells 31 can be prevented from being reduced, and the dust-proof property and water-proof property of the battery cells 31 can be both achieved. In this manner, the battery pack 11 and the electric power tool 10 to which the battery pack 11 is attached can ensure sealing properties of the battery cells 31 and ensure cooling properties of the battery cells 31.

The battery pack of the present invention is not limited to the above-described embodiment, and various modifications can be made within a range not departing from the gist thereof. Examples of the battery pack of the present invention include a structure that houses less than eight battery cells and a structure that houses nine or more battery cells. Examples of the battery pack of the present invention include a structure in which the flowing direction of the air which has entered the inside of the housing case and the direction along the center line of the battery cells are parallel. Examples of the electric device to/from which the battery pack of the present invention is attached and detached include, in addition to the above-described electric power tool, charger, etc., grinders (grinding tools), sanders (polishing tools), nailing machines, screw driving machines, tackers, dust collectors (cleaners), air blowers (fans, blowers), pumps, high-pressure washing machines, chain saws (cutting tools), gardening tools (grass cutters, hedge trimmers), and cultivators. Thus, examples of the electric device of the present invention include a device that rotates the electric motor by the electric power of the battery pack and converts the rotary motion thereof to at least one of reciprocating motion and rotary motion of a working member. Moreover, examples of the electric device of the present invention include torches (flashlight). Thus, examples of the electric device of the present invention include lighting equipment that converts the electric energy, which is supplied from the battery pack, to optical energy.

What is claimed is:

1. A battery pack comprising:
a housing case that houses a battery cell and can be attached to and detached from an electric-device main body;
an insulating covering material that covers the battery cell in a state in which electrodes of the battery cell are exposed;
a holder that retains the battery cell covered with the covering material in the housing case; and
an insulating member that covers the electrodes of the battery cell in a state in which the battery cell is retained by the holder.

2. The battery pack according to claim 1, further comprising
an opening portion that is provided on the holder and exposes a part of the battery cell covered with the covering material to a passage of air that flows in the housing case.

3. The battery pack according to claim 1,
wherein the holder aligns and retains a plurality of the battery cells in a cylindrical shape being parallel to each other along a wall of the housing case; and
the passage is formed between the wall of the housing case and the plurality of battery cells aligned and retained by the holder.

4. The battery pack according to claim 1,
wherein the passage is formed between a bottom part of the housing case and the battery cell positioned on the bottom part side.

5. The battery pack according to claim 1, further comprising
a seal material that covers a gap between an edge of the holder forming the opening portion and the battery cell being exposed from the opening portion.

6. A battery pack comprising:
a housing case that houses a battery cell and can be attached to and detached from an electric-device main body;
an insulating covering material that covers the battery cell in a state in which electrodes of the battery cell are exposed;
a holder that retains the battery cell covered with the covering material in the housing case; and
an opening portion that is provided on the holder and exposes a part of the battery cell covered with the covering material to a passage of air that flows in the housing case.

7. An electric device comprising:
a battery pack that houses a battery cell; and
an electric-device main body to and from which the battery pack can be attached and detached,
the battery pack including
a housing case that houses a battery cell and can be attached to and detached from an electric-device main body;
an insulating covering material that covers the battery cell in a state in which electrodes of the battery cell are exposed;
a holder that retains the battery cell covered with the covering material in the housing case; and
an insulating member that covers the electrodes of the battery cell in a state in which the battery cell is retained by the holder.

8. An electric device comprising:
a battery pack that houses a battery cell; and
an electric-device main body to and from which the battery pack can be attached and detached,
the battery pack including
a housing case that houses the battery cell and can be attached to and detached from the electric-device main body,
an insulating covering material that covers the battery cell in a state in which electrodes of the battery cell are exposed,
a holder that retains the battery cell covered with the covering material in the housing case, and
an opening portion that is provided in the holder and exposes apart of the battery cell covered with the covering material to a passage of air that flows in the housing case.
